(19) United States
(12) Patent Application Publication
(10) Pub. No.: US 2025/0127666 A1
(43) Pub. Date: Apr. 24, 2025

(54) LOADING ASSISTANCE DEVICE OF STRETCHER

(71) Applicant: Antar DAOUK, Paris (FR)

(72) Inventor: Antar DAOUK, Paris (FR)

(21) Appl. No.: 18/834,729

(22) PCT Filed: Jan. 31, 2023
(86) PCT No.: PCT/FR2023/050125

§ 371 Date: Jul. 31, 2024

(30) Foreign Application Priority Data
Feb. 1, 2022 (FR) 2200891

(51) Int. Cl. A61G 3/02

(52) U.S. Cl. CPC A61G 3/0227; A61G 3/0236; A61G 3/0245; A61G 3/0263; A61G 3/0272; A61G 2203/70; A61G 2220/14

(57) ABSTRACT

The invention concerns a device for assisting in loading (1) a stretcher (2) on board a vehicle, said stretcher (2) extending longitudinally between a first and a second end, said device (1) comprising at least: a substantially elongated and tiltable guide means between a substantially horizontal position and an inclined position, a first support element designed to receive said stretcher (2) towards said first end, said first support element being mounted in translation relative to said guide means so that in the inclined position, said first support element can pass from a high position to a low position. Loading assistance devices of stretchers on board vehicles.

### TECHNICAL FIELD

The present invention concerns the general technical field of loading assistance devices, and more particularly that of stretcher loading assistance devices.

The present invention concerns more precisely a device for assisting in loading a stretcher on board of a vehicle, said stretcher extending longitudinally between a first and a second end.

### PRIOR ART

The stretchers (sometimes called gurneys) are commonly used for evacuating injured people, usually in a seated or lying position. To carry out this evacuation, the rescuers very often have to place a stretcher loaded with an injured person inside a vehicle. It is particularly important that the embarking of the stretcher thus loaded takes place both in complete safety for the injured person, that is to say in relative comfort, without loading errors which could lead to the stretcher tipping over (and therefore of the injured person), and as quickly as possible, due for example to the state of medical emergency in which the injured person finds himself. The needs for security and speed of loading are most often contradictory.

This need to quickly embark the loaded stretcher can be reinforced in the context of, for example, a military operation, during the evacuation of an injured person from a combat zone, in which the protection of people (rescuers, soldiers, vehicle personnel, etc.) and property (vehicle, medical equipment, etc.) is not guaranteed.

Currently, during an evacuation operation by vehicle of a person on a stretcher, the rescuers first carry the loaded stretcher to the vehicle, then hoist it manually within the latter, generally on the interior floor of said vehicle. This hoisting step is both painful for the rescuers and uncomfortable and risky for the person on the stretcher. The arduousness for the rescuers is particularly reinforced by two factors: on the one hand, the sometimes significant weight of the person and the stretcher (particularly when it comes to transporting an injured soldier with his equipment), and on the other hand the height of the interior floor of the vehicle relative to the ground. These two factors power each other: a greater difficulty for the rescuers leads to a greater risk of discomfort and danger (tipping out of the stretcher, new injury, etc.) for the embarked person.

Stretcher transport trolleys are also known, designed to roll up to an ambulance in which the stretcher is transferred with the trolley. The trolley has legs at the end of which there is wheels. The trolley is generally foldable at its feet to enter the ambulance while embarking the stretcher. However, such trolleys cannot be used in uneven or difficult terrain, for example in the mountains or at sea. These known trolleys are also only suitable for a specific category of land ambulance vehicles of low interior floor height, the embarking must also take place on substantially flat ground and on which the trolley can roll easily (in a street for example).

### DISCLOSURE OF THE INVENTION

The objects assigned to the present invention therefore aim to remedy the various drawbacks listed above and to propose a new device for assisting in loading a stretcher on board a vehicle, which, while being particularly robust, reliable and practical, requires only a reduced effort from the rescuers and/or operators implementing it.

Another object of the invention aims to propose a new device for assisting in loading a stretcher on board a vehicle which allows rapid embarking, and under optimal safety conditions, of a stretcher loaded with a person, animal or material, inside a vehicle, and in particular an aircraft.

Another object of the invention aims to propose a new device for assisting in loading a stretcher on board a vehicle which allows a person or an animal to be embarked in a particularly comfortable manner on a stretcher on board a vehicle.

Another object of the invention aims to propose a new device for assisting in loading a stretcher on board a vehicle which requires only minimal maintenance.

Another object of the invention aims to propose a new device for assisting in loading a stretcher on board a vehicle whose weight and bulk are reduced.

Another object of the invention aims to propose a new device for assisting in loading a stretcher on board a vehicle whose manufacture is simple and can be carried out at controlled cost.

Another object of the invention aims to propose a new device for assisting in loading a stretcher on board a vehicle whose design allows it to be easily adapted to a wide variety of vehicles.

Another object of the invention aims to propose a new device for assisting in loading a stretcher on board a vehicle which is capable of being adapted to any type of stretcher, regardless of its design or its weight.

Another object of the invention aims to propose a new device for assisting in loading a stretcher on board a vehicle whose design ensures that operators/rescuers have easier access to the loaded person or equipment on said stretcher.

Another object of the invention aims to propose a new device for assisting in loading a stretcher on board a vehicle whose structure is simple and only comprises a limited number of distinct parts.

Another object of the invention aims to propose a new device for assisting in loading a stretcher on board a vehicle whose structure is durable, reliable and particularly resistant.

Another object of the invention aims to propose a new loading system allowing a person, an animal or equipment to be embarked into a vehicle in a practical, rapid manner and in optimal safety conditions.

Another object of the invention aims to propose a new vehicle capable of embarking a person, an animal or equipment within it in a practical, rapid manner and in optimal safety conditions.

The objects assigned to the present invention are achieved using a device for assisting in loading a stretcher on board a vehicle, said stretcher extending longitudinally between a first and a second end, said device comprising at least:
a support assembly intended to be secured to said vehicle, for example to the floor of said vehicle,
a substantially elongated and tiltable guide means between a substantially horizontal position and an inclined position, said guide means being rotatably mounted relative to said support assembly along at least one primary axis of rotation which is substantially vertical, and
a first support element designed to receive said stretcher towards said first end, said first support element being mounted in translation relative to said guide means so that in the inclined position, said first support element can move from a high position to a low position.

The objects assigned to the present invention are also achieved using a loading system comprising at least one stretcher and a device for assisting in loading said stretcher in accordance with the invention as described above.

The objects assigned to the present invention are also achieved using a vehicle equipped with a device for assisting in loading a stretcher in accordance with the invention as described above.

### BRIEF DESCRIPTION OF DRAWINGS

Other objects and advantages of the invention will emerge in more detail on reading the description which follows, and with the aid of the appended figures provided for purely explanatory and non-limiting purposes, in which:

FIG. 1 illustrates schematically, in a perspective view, a loading assistance device according to the invention according to a particular embodiment, in a substantially horizontal and retracted position.

FIG. 2 illustrates schematically, in a perspective view, the loading assistance device of FIG. 1, with the difference that it is in the deployed position.

FIG. 3 illustrates schematically, in a perspective view, the loading assistance device of FIG. 2, with the difference that it is in an inclined position, with a first support element of the device in the high position.

FIG. 4 illustrates schematically, in a perspective view, the loading assistance device of FIG. 3, with the difference that the first support element is in the low position.

FIG. 5 illustrates schematically, in a perspective view, the loading assistance device of FIG. 4, as well as a stretcher supported by the first support element.

FIG. 6 illustrates schematically, in a perspective view, the loading assistance device and the stretcher of FIG. 5, the stretcher being further supported by a second support element of the device.

### BEST WAY TO REALIZE THE INVENTION

The invention concerns, according to a first aspect illustrated in the figures, a loading assistance device 1 of a stretcher 2 on board a vehicle. Thus, the loading assistance device 1 is advantageously designed to assist carrying out the embarking of a stretcher 2 within said vehicle. Said stretcher 2 is preferably «loaded», that is to say it is designed and intended to support and allow the transport of a person, for example an injured person, an animal, and/or objects, for example medical or military equipment. Thus, advantageously, the term «stretcher» encompasses the stretcher 2 as such, but also its possible load, whether human, animal, and/or material. Of course, the loading assistance device 1 is also suitable for loading the stretcher 2 alone, that is to say unloaded. The vehicle is for example an automobile, a utility vehicle (truck, fire engine, etc.), an ambulance, an aircraft, a ship, etc. According to a particular embodiment, the vehicle is an aircraft, for example an ambulance aircraft. Preferably, said vehicle is a helicopter, for example an ambulance helicopter. According to a particular variant, the vehicle is a military aircraft, for example a military helicopter or a military plane (for example as an ambulance). Said vehicle may have an interior floor which, according to a particular embodiment, is at a height, relative to the ground when the vehicle is placed on it, greater than 60 cm, preferably greater than 80 cm, more preferably greater than 100 cm or even greater than 120 cm. This height, which can therefore be relatively high, therefore requires hoisting the stretcher 2 well above the ground to put it in the vehicle, on the interior floor of the latter for example. The inherent thickness of the stretcher 2 alone can further complicate this operation, since it increases the hoisting height. The hoisting height (sum of the height of the floor and thickness of the stretcher 2 for example) and the sometimes significant weight of the stretcher 2 (particularly when loaded) make it particularly difficult to embark the stretcher 2 by the vehicle when it is carried out in a purely manual manner by rescuers and/or operators. The loading assistance device 1 of the invention makes this embarking easier for the rescuers and/or operators, but also more secure for the person, the animal or the material transported on the stretcher 2. As can be seen later, the loading assistance device 1 is preferably intended to be secured to said vehicle, via for example a support assembly 11 of the device 1.

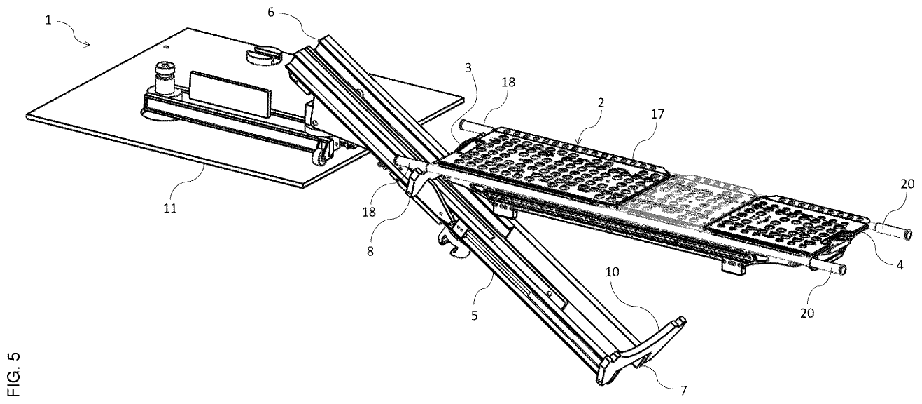

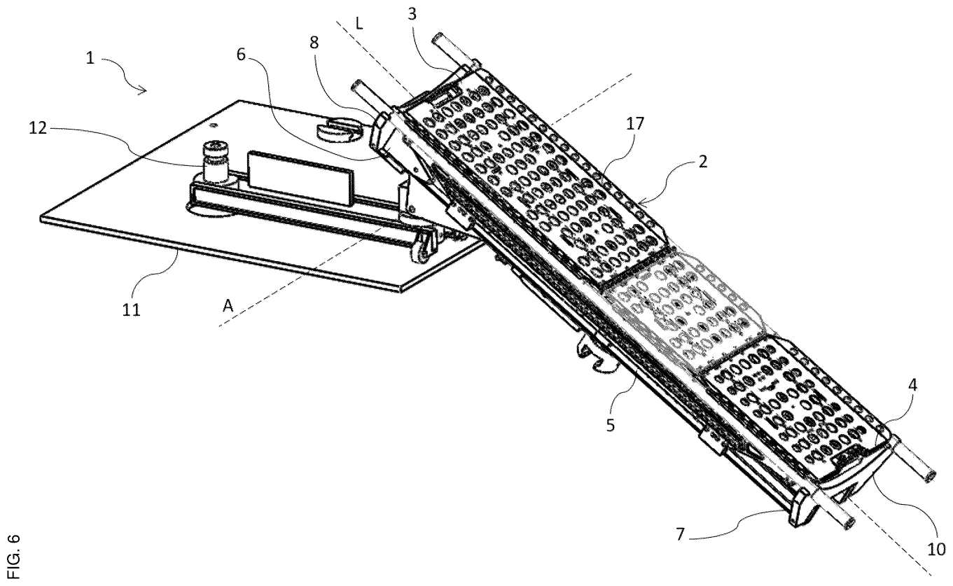

According to the invention, said stretcher 2 extends longitudinally between a first and a second end 3, 4. The stretcher 2 is preferably designed to be grasped at the first end 3 by one or more operators/rescuers, and at level of the second end 4 by one or more other operators/rescuers. By convention, the first end 3 is preferably the one which must enter the vehicle first when loading the stretcher within the latter, while the second end 4 enters afterwards. An example of stretcher 2 in accordance with the invention is illustrated in FIGS. 5 and 6.

The stretcher 2 has, according to a particular embodiment, a generally rectangular shape, but it can have, according to other alternatives, a different general shape, for example a general substantially ovoid, oval, triangular, etc. shape.

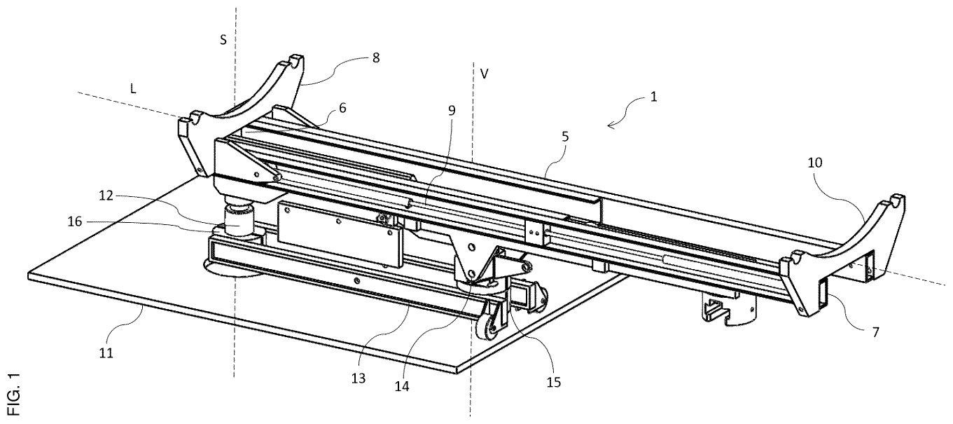

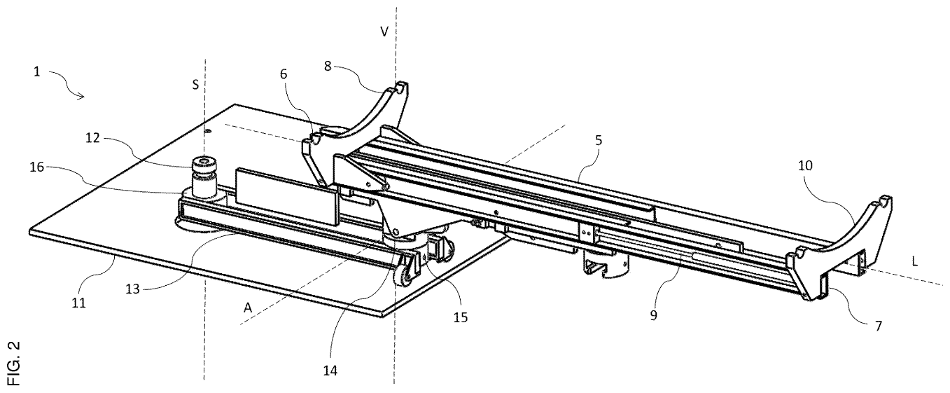

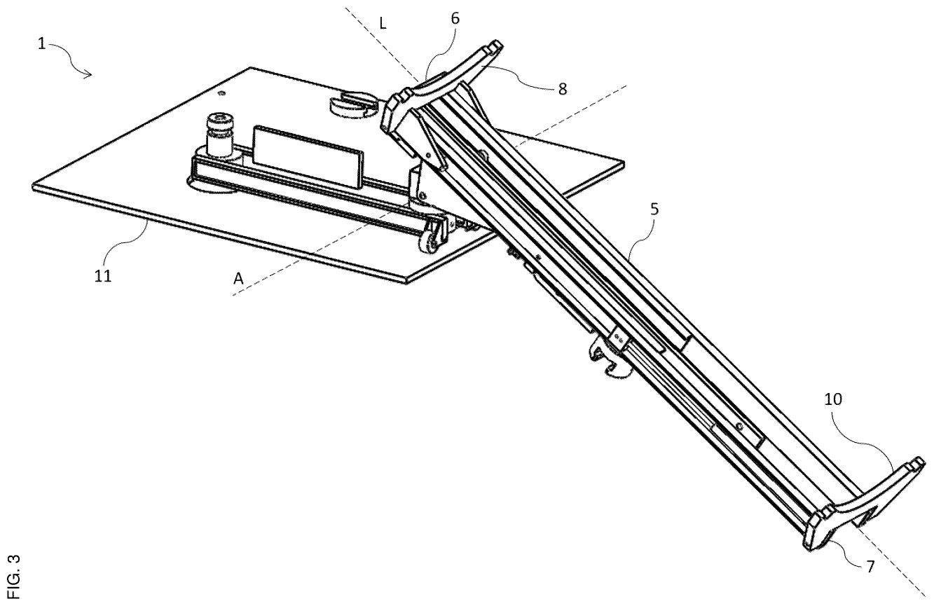

According to the invention, said device 1 comprises at least one guide means 5 substantially elongated and tiltable between a substantially horizontal position and an inclined position. In other words, the device 1 is preferably designed so that said guide means 5 can be placed substantially horizontal (in a substantially horizontal position) then inclined, that is to say obliquely (nor vertically or horizontally), in an inclined position, and vice versa, going from oblique to horizontal. An example of guide means 5 in a substantially horizontal position is illustrated in FIGS. 1 and 2, and an example of guide means 5 in an inclined position is illustrated in FIGS. 3 to 6.

Said guide means 5 advantageously extends in a direction of longitudinal extension L. The latter is preferably oriented substantially horizontally when said guide means 5 is in a substantially horizontal position, and oriented substantially obliquely when said guide means 5 is in inclined position. In the inclined position, the direction of longitudinal extension L forms for example an angle comprised between 5 and 70° with the horizontal plane, preferably comprised between 10 and 60°, more preferably comprised between 15 and 50°. The guide means 5 preferably extends longitudinally, that is to say advantageously along said direction of longitudinal extension L, between a primary end 6 and a secondary end 7. In the inclined position, the primary end 6 is preferably located at an altitude greater than that of the secondary end 7.

Advantageously, the inclination of said guide means 5 is carried out along a first axis of rotation A substantially perpendicular to said direction of longitudinal extension L. The loading assistance device 1 is, according to a particular variant, designed so that the guide means 5 can move from said substantially horizontal position to said inclined position and vice versa by rotation along a substantially horizontal axis of rotation. Thus, said first axis of rotation A is preferably substantially horizontal, although other alternatives exist (it could possibly be oblique).

Said guide means 5 preferably comprises a rail (as illustrated in the figures), a profile, and/or a guide post, but it may comprise any other substantially elongated shape which is suitable.

According to the invention, the loading assistance device further comprises at least one first support element 8 designed to receive said stretcher 2 towards said first end 3. Said first support element 8 is therefore advantageously designed to support and possibly be attached to at least one part of said stretcher 2, more precisely a part of said stretcher 2 located in the vicinity of said first end 3 (and preferably opposite said second end 4).

Said first support element 8 is advantageously designed to enter into mechanical connection with said stretcher 2 so as to remove at least one degree of freedom from the latter. Said first support element 8 can possibly be designed to enter into mechanical connection with said stretcher 2 so as to remove at least one other degree of freedom from the latter, said first support element 8 then being designed to enter into mechanical connection with said stretcher 2 so as to remove at least two degrees of freedom from the latter. Said first support element 8 is, according to a particular variant, designed to be attached to said stretcher 2, for example to the handles thereof (when said stretcher 2 has such handles).

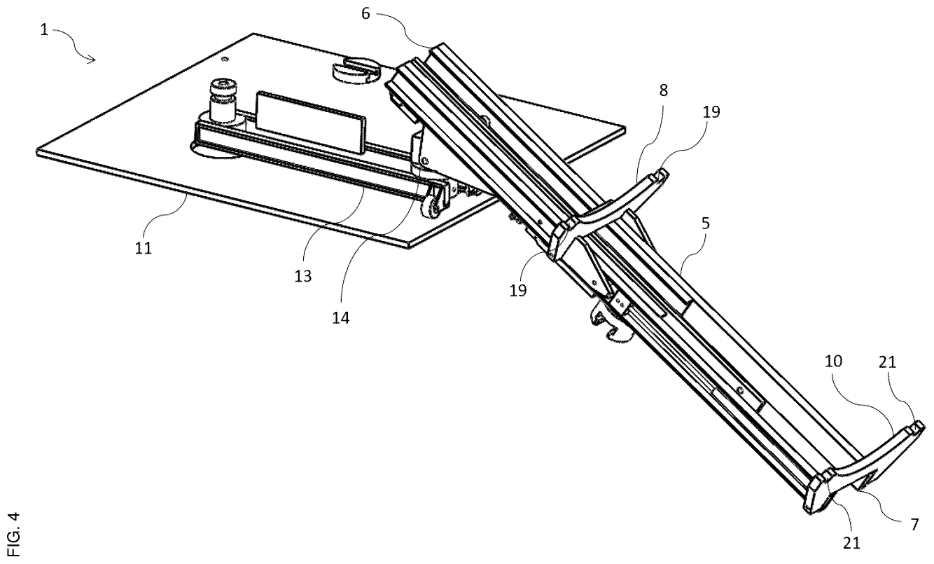

Still according to the invention, said first support element 8 is mounted in translation relative to said guide means 5 so that in the inclined position, said first support element 8 can move from a high position to a low position. Thus, said device 1 is preferably designed so that said first support element 8 can move from the high position to the low position, and vice versa, via a translational movement, which translational movement is advantageously carried out along said guide means 5. The first support element 8 comprises for example a trolley designed to slide along said guide means 5 following a translation movement, preferably in a direction parallel to or coincident with the direction of longitudinal extension L of the guide means 5, said trolley being designed to carry said stretcher 2 towards said first end 3. An example of first support element 8 in the high position is illustrated in FIGS. 3 and 6, and an example of first support element 8 in the low position is illustrated in FIGS. 4 and 5. The high position preferably corresponds to a first altitude at which the first support element 8 is located, and the low position advantageously corresponds to a second altitude at which the first support element 8 is located, said second altitude being lower than said first altitude. The first support element 8 is preferably designed to move from the high position to the low position, and vice versa, by carrying out a translation movement in a direction parallel to or coincident with said direction of longitudinal extension L. Preferably, when the first support element 8 moves from the high position to the low position, it moves away from said primary end 6 and approaches said secondary end 7, and when the first support element 8 moves from the low position to the high position, it moves away from said secondary end 7 and approaches said primary end 6. The first support element 8 is thus advantageously designed to, while it supports the stretcher 2 (or at least part thereof), move from the low position to the high position according to a translation movement following a direction parallel or coincident with the direction of longitudinal extension L of the guide means 5. Advantageously, this allows the stretcher 2 or part of it to move from a lower altitude to a higher altitude while being supported by the first support element 8 instead of being supported manually by one or more rescuers/operators, thus considerably reducing the difficulty of embarking the stretcher for them. Said rescuers/operators only have to push (upwards) said stretcher 2 and/or said first support element 8, from the lower altitude and/or from the lower position to the higher altitude and/or to the high position, said first support element 8 sliding for example from the low position to the high position along said guide means 5 while supporting said stretcher 2. During the operation of loading the stretcher 2 on board the vehicle, at least part of the weight of the stretcher 2 (and therefore of its loading) is advantageously supported by the first support element 8 and therefore by the guide means 5, instead of being supported (only) by the operators/rescuers. Once the first support element 8 has returned to the high position supporting the stretcher 2 (FIG. 6), it suffices for example to return the guide means 5, still loaded with the stretcher 2, from its inclined position to its substantially horizontal position (FIG. 2 in which it would be necessary to add the stretcher 2 of FIG. 6), part or all of the weight of the stretcher 2 being advantageously already supported by the loading assistance device 1 and therefore indirectly by the vehicle.

Preferably, the loading assistance device 1 comprises at least one first return means 9 designed to exert a return force of the first support element 8 towards the high position when said first support element 8 is positioned in the low position and/or is located between the high and low positions. Said first return means 9 comprises for example at least one gas cylinder, a spring, and/or an elastic return element. A first return means 9 in the form of one or more gas cylinders is illustrated in FIG. 1 (two cylinders) and in FIG. 2 (a single cylinder), the size and positioning of this or these gas cylinders (and more generally of the first return means 9) which may vary. Said first return means 9 advantageously makes it possible to facilitate the passage of the first support element 8 from the low position to the high position, in particular when it receives said stretcher 2. Said first return means 9 therefore preferentially forms an assistance making it possible to facilitate the passage of the stretcher 2 or a part thereof received by the first support element 8 from a lower altitude to a higher altitude. The first return element 9 should advantageously not be too powerful, because it is preferably designed so that the descent (by translation) of the first support element 8 from the high position to the low position can be done manually, that is to say by operators/rescuers by simply pulling or pushing the first support element 8 downwards (and more precisely towards said secondary end 7) when the guide means 5 is in the inclined position. Thus, said first return means 9 is advantageously designed to exert said return force of the first support element 8 towards said primary end 6. Said first return means 9, which remains optional, is therefore preferably designed to drive said first support element 8 away from said secondary end 7.

The loading assistance device 1 comprises, according to a particular variant, a displacement means designed to displace the first support element 8 towards the high position when the latter is positioned in the low position and/or is located between the high and low positions. Said displacement means is therefore preferably designed to displace the first support element 8 towards said primary end 6. Said displacement means comprises for example a crank, as well as possibly a set of gears and/or a linked belt to said crank. Said displacement means advantageously makes it possible to displace the first support element 8 along the guide means 5. Said displacement means is preferably designed to be actuated manually, but can alternatively be actuated electrically, pneumatically, and/or hydraulically. According to a particular embodiment, the displacement means comprises the first return means 9 described above and/or the second return means described below, either alone or in combination with another means such as said crank (and possibly said set of gears and/or said belt).

According to a particular alternative, not illustrated, the loading assistance device 1 comprises at least one second return means designed to exert a return force of the first support element 8 towards the low position when said first support element 8 is positioned in high position and/or is located between the low and high positions. Said second return means comprises for example at least one gas cylinder, a spring, and/or an elastic return element. Said second return means thus exerts a return force opposite to the return force exerted by said first return means 9. Said first return means 9 advantageously makes it possible to facilitate the passage of the first support element 8 from the high position to the low position, in particular before receiving said stretcher 2, so as to reduce the effort required of the rescuers/operators when they seek to lower the first support element 8 from its high position to its low position. Said second return means therefore preferentially forms an assistance making it possible to facilitate the passage of the first support element 8 from said high position to said low position. Thus, said second return means is advantageously designed to exert its return force from the first support element 8 towards said secondary end 7. Said second return means is therefore preferably designed to drive said first support element 8 away from said primary end 6. Preferably, the return force exerted by the first return means 9 is greater than the return force exerted by the second return means. Such a configuration makes it possible to prioritize the loading of the stretcher 2, in particular when the first support element 8 passes from the low position to the high position by supporting said stretcher 2, on the descent of the first support element 8 from the high position to the low position carried out for example by one or more rescuers/operators.

Advantageously, the loading assistance device 1 further comprises a second support element 10 designed to receive said stretcher 2 towards said second end 4. Said second support element 10 is therefore advantageously designed to support and possibly be attached to at least one part of said stretcher 2, more precisely a part of said stretcher 2 located in the vicinity of said second end 4 (and preferably opposite said first end 3). Preferably, said second support element 10 is secured to said guide means 5. Alternatively, said second support element 10 is part of another assembly than the guide means 5. Said second support element 10 has for example a substantially similar and/or symmetrical shape to that of the first support element 8, as illustrated in the figures. Such a configuration makes the manufacture of the device 1 less expensive and its use simpler.

According to a particular embodiment, said second support element 10 is, as illustrated in the figures, completely secured to said guide means 5, and therefore has no degree of freedom with respect to the latter. Such a configuration makes it possible to confer excellent robustness to the device 1, the second support element 10 being advantageously designed to support at least part, or even most of the weight of the stretcher 1 when the guide means 5 is in an inclined position, as shown in FIG. 6.

Preferably, said second support element 10 is fixed to the guide means 5 towards or at said secondary end 7, as illustrated in the figures. Alternatively or in combination with the above, said second support element 10 forms all or part of said secondary end 7.

Advantageously, when said guide means 5 is in an inclined position, said second support element 10 is at an altitude which is lower than that of said first support element 8. When said guide means 5 is in a substantially horizontal position, said second support element 10 is advantageously (but not necessarily) at an altitude which is substantially similar to that of said first support element 8. When said first support element 8 is in the low position, it is preferably closer to the second support element 10 than when it is in the high position.

Said second support element 10 is advantageously designed to enter into mechanical connection with said stretcher 2 so as to remove at least one degree of freedom from the latter. Said second support element 10 can optionally be designed to enter into mechanical connection with said stretcher 2 so as to remove at least one other degree of freedom from the latter, said second support element 10 then being designed to enter into mechanical connection with said stretcher 2 so as to remove at least two degrees of freedom from the latter. Said second support element 10 is, according to a particular variant, designed to be attached to said stretcher 2, for example to the handles thereof (when said stretcher 2 has such handles).

Thus, the loading assistance device 1 is preferably designed so that the first support element 8, when it is in the low position (FIG. 4), receives said stretcher 2 towards said first end 3 (FIG. 5), then that the first support element 8 passes into the high position with at least part of the stretcher 2 carried by the latter, the second support element 10 then receiving said stretcher 2 towards said second end 4, said stretcher 2 then being preferably entirely supported by said first and second support elements 8, 10 (FIG. 6). In other words, said stretcher 2 is advantageously carried by said guide means 5 via said first and second support elements 8, 10, said first support element 8 being mounted in translation relative to said guide means 5, while said second support element 10 is preferably fixedly mounted, completely secured, with said guide means 5.

Advantageously, the loading assistance device 1 further comprises, as illustrated in the figures, at least one support assembly 11 intended to be secured to said vehicle, for example to the (interior) floor of said vehicle. Alternatively, said support assembly 11 can be fixed to an interior lateral wall of said vehicle, or to a part of the latter. Said support assembly 11 comprises for example a plate, said plate being according to a particular variant intended to be secured to the floor of the vehicle, more precisely against the latter, said plate therefore being intended to be positioned substantially horizontally. Said support assembly 11 can be secured to the vehicle, for example to the interior floor of the latter, by screwing, welding, clipping, blocking by rail (for example those commonly found on the floor of certain aircraft such as helicopters), etc. Said support assembly 11 is also advantageously connected to the guide means 5.

According to a particular variant of the invention, said guide means 5 is mounted in translation relative to said support assembly 11 so that in a substantially horizontal position, said guide means 5 can move from a retracted position (FIG. 1) to a deployed position (FIG. 2) in which it is further from a proximal point 12 of said support assembly 11 than in said retracted position. Said proximal point 12 is advantageously intended to be positioned inside said vehicle. In said retracted position, the guide means 5 is preferably positioned entirely or partly in the vehicle, and in said deployed position, said guide means 5 can be positioned entirely or partly outside the vehicle, the guide means 5 being optionally located further outside the vehicle in the deployed position than in the retracted position. The proximal point 12 can for example be a zone of the support assembly 11, for example a part of said plate and/or a portion of the support assembly above said plate. Said guide means 5 comprises for example a lower rail, preferably positioned facing the support assembly 11 when the guide means 5 is in the retracted position, said lower rail making it possible to carry out a translation movement to move from a position to the other between the retracted position and the deployed position.

According to a particular embodiment, the passage from one position to another between said retracted and deployed positions is carried out according to a translation movement in a direction parallel to or coincident with said direction of longitudinal extension L. Said proximal point 12 is for example on or to the right of said direction (of translation) parallel to or coincident with said direction of longitudinal extension L.

Advantageously, the loading assistance device 1 further comprises a locking means (not illustrated) designed to block said guide means 5 in position when it is in said retracted position and/or in said deployed position. Said locking means is therefore preferably designed to block at least one degree of freedom of said guide means 5 relative to the support assembly 11. More precisely, said locking means is therefore advantageously designed to prevent the translation, for example in the horizontal plane and/or in the direction of longitudinal extension L, of said guide means 5 relative to the support assembly 11. Obviously, the locking means is designed to be unlocked at will, for example manually by the rescuers/operators.

According to a particular embodiment which may constitute an invention as such, carried out in isolation or in combination with the above, the loading assistance device 1 is designed so that, in a substantially horizontal position, it allows the loading translational movement, preferably substantially horizontal (and along the direction of longitudinal extension L), of said stretcher 2 from a first positioning (substantially horizontal) within the vehicle to at least one second positioning (substantially horizontal) within the vehicle, and vice versa, the second positioning advantageously allowing at least part of the stretcher 2 to be placed in a rear part of said vehicle, and more precisely an internal space at the rear of said vehicle with respect to the forward displacement of the latter. Said translational displacement of the stretcher 2 is advantageously carried out in the direction in which the length of the stretcher 2 extends. Obviously, the first positioning is preferably distinct and distant from the second positioning, the stretcher 2 not being located at the same location of the internal space of the vehicle in each of said first and second positions. For example, the second positioning corresponds to a placement of an individual on the stretcher 2 so that his legs are at least partly located in said rear part of the vehicle, which is for example the tail of an aircraft, and notably the tail of a helicopter. Such a configuration allows both to maximize the use of the restricted interior space of the helicopter (or other vehicle), but also for rescuers/operators to more easily access the head and/or trunk of the body of the individual on the stretcher 2, the injuries being very often located in these parts of the body. For example, the first positioning of the stretcher 2 corresponds to the retracted position of the guide means 5 with the latter entirely within the vehicle, while the second positioning of the stretcher 2 corresponds to the deployed position of the guide means 5 with the latter entirely within the vehicle (contrary to what seen in FIGS. 1 and 2, but the translation movement is substantially the same). In the first positioning, the stretcher 2 occupies in particular a more «central» position within the internal space of the vehicle than in the second positioning, and therefore limits the movements of the rescuers/operators more than when it is in the second positioning, in which at least part of the stretcher 2 occupies the rear of the vehicle, which is frequently considered as «wasted» space because it is not easily accessible by the crew or the rescuers/operators, particularly in the case of the tail of an aircraft. The loading assistance device 1 is also advantageously designed to be able to block said stretcher 2 in said first positioning and/or second positioning, that is to say prevent said stretcher 2 from moving in translation from the first positioning to the second positioning and/or from the second positioning to the first positioning, for example using said locking means. This makes it possible to secure the stretcher 2 in the horizontal plane during its transport within the vehicle.

According to the invention, said guide means 5 is rotatably mounted relative to said support assembly 10 along at least one primary axis of rotation V which is substantially vertical. Preferably, said guide means 5 can be placed, by rotation along (at least) said primary axis of rotation V, in a first transport position (not illustrated), in which the direction of longitudinal extension L is preferably substantially parallel to or coincident with the direction of forward displacement of said vehicle. The rotation of said guide means 5 relative to said support assembly 10 is advantageously achievable (and preferably only) when the guide means 5 is in a substantially horizontal position, and preferably in a retracted position. The primary axis of rotation V and the first axis of rotation A are preferably intersecting, and more preferably substantially orthogonal to each other.

According to a particular variant, said guide means 5 is rotatably mounted relative to said support assembly 10 along at least one secondary axis of rotation S which is advantageously substantially vertical, said secondary axis of rotation S being preferably distinct and distant from said primary axis of rotation V. Said secondary axis of rotation S passes for example through the proximal point 12. Said primary axis of rotation P and said secondary axis of rotation S are preferably substantially parallel to each other.

The loading assistance device 1 advantageously comprises, as illustrated in the figures, an interconnection means between said guide means 5 and said support assembly 11. Said interconnection means comprises for example at least one, several or all of the following elements:
a spacer 13 extending, preferably longitudinally, between a third end and a fourth end,
a first hinge 14, preferably at said fourth end, ensuring a pivot connection between said spacer 13 and said guide means 5 along the first axis of rotation A,
a second hinge 15, preferably at said fourth end, ensuring a pivot connection between said spacer 13 and said guide means 5 along the primary axis of rotation V, said first and second hinges 14, 15 being able to be at least partly superimposed and/or confused as illustrated in the figures,
a third hinge 16, preferably at said third end, ensuring a pivot connection between said spacer 13 and said support assembly 11 along the secondary axis of rotation S, said third hinge 16 therefore being preferably distinct and distant from said first hinge 14 and/or said second hinge 15, said proximal point 12 being for example formed by said third hinge 16 or a part thereof.

Such a configuration, where the guide means 5 can rotate along two (distinct) vertical axes (primary V and secondary S axes of rotation) relative to the support assembly 11, advantageously makes it possible to optimize the positioning of the stretcher 2 to the inside the vehicle, when said stretcher 2 is supported by the loading assistance device 1 preferably in a substantially horizontal position and in a retracted position. This makes it possible to optimize the internal space of the vehicle and/or to place the stretcher 2 in a practical position for the operators/rescuers, for example if they have to provide care to an injured person on the stretcher 2.

According to a particular embodiment, illustrated in FIGS. 5 and 6, said stretcher 2 comprises a receiving plate 17 as well as, towards said first end 3, two primary arms 18 projecting out of said receiving plate 17. This configuration is quite common among 2 stretchers, although other configurations are possible. Said first support element 8 advantageously comprises at least two receiving means 19 each designed to receive one of said two primary arms 11. According to a particular embodiment, alone or in combination with the above, illustrated in FIGS. 5 and 6, said stretcher 2 comprises, towards said first end 3, two secondary arms 20 projecting out of said receiving plate 17. Said second support element 10 then advantageously comprises at least two receiving means 21 each designed to receive one of said two secondary arms 20. Each arm 18, 20 advantageously forms a respective handle of said stretcher 2. Each receiving means 19, 21 comprises for example a recessed shape complementary to the arm 18, 20 which it is intended to receive. Each primary arm 18 is possibly an extension of and secured to one of said corresponding secondary arms 20. Advantageously, each arm 18, 20 extends in a direction substantially parallel to or coincident with said direction of longitudinal extension L. Said arms 18, 20 preferably extend substantially in the extension of the receiving plate 17. Advantageously, one, several, or each of the receiving means 19, 21 comprises a respective blocking system designed to block the corresponding arm 18, 20 in position, such a configuration making it possible in particular to secure the stretcher 2 (and therefore the injured individual on it) once it is placed on the reception means 19, 21. Obviously, each blocking system can be locked and unlocked at will, for example manually by the rescuers/operators.

According to an example of implementation of the invention, given for informational and non-limiting purposes, the guide means 5 first passes from a transport position (not illustrated), in which the direction of longitudinal extension L is substantially parallel or coincident with the direction of forward displacement of said vehicle, at a preliminary loading position, as illustrated in FIG. 1. The guide means 5 achieves for example an overall rotation of 90° horizontally between the transport position and the preliminary loading position, which corresponds in practice to the retracted position and the substantially horizontal position of the guide means 5, in FIG. 1. The guide means 5 then passes from the retracted position, as illustrated in FIG. 1, in the deployed position, as illustrated in FIG. 2, by translation of said guide means 5 relative to the support assembly 11. The guide means 5 remains substantially horizontal in the deployed and retracted positions. This makes it possible to «unblock» the inclination of the guide means 5. The guide means 5 can then move from the substantially horizontal position (FIG. 2) to the inclined position (FIG. 3) by rotation along the first axis of rotation A, then the first support element 8 passes from the high position (FIG. 3) to the low position (FIG. 4) by translation, for example using manual pulling by one or more rescuers/operators, possibly assisted by a second return means. The stretcher 2 is then loaded onto the first support element 8, all the more easily as it is in the low position (FIG. 5). To this end, the primary arms 18 are placed on the receiving means 19 of the first support element 8, so as to block at least partially said stretcher 2 towards said first end 3 on said first support element 8 (removal of at least one degree of freedom of the stretcher 2). Said stretcher 2 is then pushed by the rescuer(s)/operators, for example via said secondary arm 20, upwards (and towards the interior of the vehicle), and more precisely towards the primary end 6 of the guide means 5. The first support element 8 then rises along the guide means 5, translating upwards until returning to the high position. Then, the secondary arms 20 are placed on the receiving means 21 of the second support element 10, so as to block at least partially said stretcher 2 towards said second end 4 on the second support element 10 (removal of at least one degree of freedom of the stretcher 2), as illustrated in FIG. 6. It is then sufficient for the rescuers/operators to raise the guide means 5, for example by lifting it by the secondary end 7 or said second support element 10, to pass guide means 5, which is therefore loaded with said stretcher 2, from the inclined position to the substantially horizontal position, which would correspond to FIG. 2 to which it would be necessary to add the stretcher 2 of FIG. 6, said stretcher 2 being then horizontal. The guide means 5 then passes from the deployed position to the retracted position, which allows at least part of the stretcher to be placed inside the vehicle, which would correspond to FIG. 1 to which the stretcher 2 of FIG. 6 would have to be added. Finally, the guide means 5, loaded with the stretcher 2, passes from the preliminary loading position (FIG. 1 to which the stretcher of FIG. 6 should be added) to the transport position (not shown) on the one hand by rotation (at 90° for example) of the spacer 13 relative to the support assembly 11 along the secondary axis of rotation S, and on the other hand by rotation (at 180° for example), of the spacer 13 relative to the guide means 5, which results in a rotation (at 90° for example) between the guide means 5 and the support assembly 11 while optimizing the internal space of the vehicle. In summary, to simplify, the inclination of the guide means 5 and the translation between the high and low positions of the first support element 8 make it possible to facilitate the embarking of the stretcher 2 by the device 1 and therefore by the vehicle, while the rotation of the guide means 5 horizontally (along the primary V and secondary axes S) and the passage of the latter into the retracted or deployed position make it possible to better manage the position of the stretcher 2 within the vehicle and therefore its position relative to the operators/rescuers who can for example assist an injured person on said stretcher 2. Optionally, within the vehicle, the stretcher 2 then passes from the first positioning to the second positioning by horizontal translation, in order to place a part of the stretcher 2 and of the individual (his legs for example) in the rear part of the internal space of the vehicle, such as the tail of a helicopter. In practice, the passage from the first positioning to the second positioning can be carried out by sliding the guide means 5 in translation relative to the support assembly 11 from the retracted position to the deployed position, the guide means 5 this time remaining entirely within the vehicle in both positions. Once the stretcher 2 is at least partly in the rear part of the vehicle, in the second positioning, the locking means is implemented in order to block the guide means 5 (which is therefore in the deployed position) to secure the stretcher and therefore in particular the injured individual embarked by the latter.

The invention concerns, according to a second aspect illustrated in FIGS. 5 and 6, a loading system comprising at least one stretcher 2 and a loading assistance device 1 of said stretcher 2 as described previously. The stretcher 2 and the loading assistance device 1 are therefore advantageously as described above. The stretcher 2 of the loading system is therefore preferably designed to be received (by), and possibly secured, to the loading assistance device 1.

The invention concerns, according to a third aspect, a vehicle equipped with a loading assistance device 1 of a stretcher 2 as described previously. The vehicle, the loading assistance device 1 and the stretcher 2 are therefore advantageously as described above. The vehicle and the loading assistance device 1 are for example secured to each other via the support assembly 11 secured to the interior floor of the vehicle. The loading assistance device 1 is therefore advantageously designed to help loading said stretcher 2 on board said vehicle.

The loading assistance device 1 of the invention makes it possible to quickly, safely and practically load a stretcher 2 on board a vehicle, while minimizing the effort necessary for rescuers/operators to carry out this loading.

According to a particular aspect, which may possibly constitute an invention in its own right, the common elements of which are advantageously the same as those mentioned above, the invention further concerns a loading assistance device 1 of a stretcher 2 on board a vehicle, said stretcher 2 extending longitudinally between a first and a second end 3, 4, said device 1 comprising at least:
a guide means 5 substantially elongated and tiltable between a substantially horizontal position and an inclined position,
a first support element 8 designed to receive said stretcher 2 towards said first end 3, said first support element 8 being mounted in translation relative to said guide means 5 so that in the inclined position, said first support element 8 can pass from a high position to a low position,
a first return means 9 designed to exert a return force of the first support element 8 towards the high position when said first support element 8 is positioned in the low position and/or is located between the high and low positions.

Obviously, this last particular aspect of the invention can be combined with one or more of the elements mentioned above in the other aspects of the invention.

### POSSIBILITY OF INDUSTRIAL APPLICATION

The invention finds its industrial application in the design, manufacture and use of devices for assisting in loading stretcher(s) on board vehicles, in particular military aircraft and/or ambulance aircraft. The invention also finds its industrial application in the design, manufacture and use of a loading system comprising such a loading assistance device and a stretcher, as well as in the design, manufacture and use of a vehicle equipped with such a stretcher loading assistance device.

1. A loading assistance device (1) of a stretcher (2) on board a vehicle, said stretcher (2) extending longitudinally between a first and a second end (3, 4), said device (1) comprising at least:
a support assembly (11) intended to be secured to said vehicle, for example to the floor of said vehicle,
a guide means (5) substantially elongated and tiltable between a substantially horizontal position and an inclined position, said guide means (5) being rotatably mounted relative to said support assembly (11) along at least one primary axis of rotation (V) which is substantially vertical,
a first support element (8) designed to receive said stretcher (2) towards said first end (3), said first support element (8) being mounted in translation relative to said guide means (5) so that in inclined position, said first support element (8) can move from a high position to a low position.

2. The loading assistance device (1) according to claim 1, characterized in that said first support element (8) is designed to enter into mechanical connection with said stretcher (2) so as to eliminate at least one degree of freedom to the latter.

3. The loading assistance device (1) according to claim 1, characterized in that it comprises at least one first return means (9) designed to exert a return force of the first support element (8) towards the high position when said first support element (8) is positioned in the low position and/or is located between the high and low positions.

4. The loading assistance device (1) according to claim 3, characterized in that said first return means (9) comprises at least one gas cylinder, a spring, and/or an elastic return element.

5. The loading assistance device (1) according to claim 1, characterized in that said guide means (5) extends in a direction of longitudinal extension (L), and in that the first support element (8) is designed to move from the high position to the low position, and vice versa, by carrying out a translation movement in a direction parallel to or coincident with said direction of longitudinal extension (L).

6. The loading assistance device (1) according to claim 1, characterized in that said guide means (5) comprises a rail, a profile, and/or a guide post.

7. The loading assistance device (1) according to claim 1, characterized in that it further comprises a second support element (10) designed to receive said stretcher (2) towards said second end (4), said second support element (10) being secured to said guide means (5).

8. The loading assistance device (1) according to claim 7, characterized in that when said guide means (5) is in an inclined position, said second support element (10) is at an altitude which is lower than that of said first support element (8).

9. The loading assistance device (1) according to claim 7, characterized in that when said first support element (8) is in the low position, it is closer to the second support element (10) than when it is in the high position.

10. The loading assistance device (1) according to claim 1, characterized in that said stretcher (2) comprises a receiving plate (17) as well as, towards said first end (3), two primary arms (18) projecting out of said receiving plate (17), and in that said first support element (8) comprises at least two receiving means (19) each designed to receive one of said two primary arms (18).

11. The loading assistance device (1) according to claim 5, characterized in that the inclination of said guide means (5) is carried out along a first axis of rotation (A) substantially perpendicular to said direction of longitudinal extension (L).

12. The loading assistance device (1) according to claim 1, characterized in that said guide means (5) is mounted in translation relative to said support assembly (11) so that in a substantially horizontal position, said guide means (5) can move from a retracted position to a deployed position in which it is further from a proximal point (12) of said support assembly (11) than in said retracted position, said proximal point (12) being advantageously intended to be positioned inside said vehicle.

13. The loading assistance device (1) according to claim 12, characterized in that said guide means (5) extends in a direction of longitudinal extension (L), the passage from one position to the other between said retracted and deployed positions being carried out according to a translation movement in a direction parallel to or coincident with said direction of longitudinal extension (L).

14. The loading assistance device (1) according to claim 1, characterized in that said guide means (5) extends in a direction of longitudinal extension (L), and in that said guide means (5) can be placed, by rotation along said primary axis of rotation (V), in a first transport position, in which the direction of longitudinal extension (L) is substantially parallel to or coincides with the direction of forward displacement of said vehicle.

15. The loading system comprising at least one stretcher (2) and an assistance device (1) for loading said stretcher (2) according to claim 1.

16. A vehicle equipped with a loading assistance device (1) for a stretcher (2) according to claim 1.
